(19) United States
(12) Patent Application Publication
(10) Pub. No.: US 2025/0025961 A1
(43) Pub. Date: Jan. 23, 2025

(54) DEVICE FOR THE COLLECTIVE TREATMENT OF SURFACES OF A PLURALITY OF OBJECTS

(71) Applicant: SLCR-Lasertechnik GmbH, Düren (DE)

(72) Inventor: Olav G. SCHULZ-GAUS, Bergheim (DE)

(21) Appl. No.: 18/775,401

(22) Filed: Jul. 17, 2024

(30) Foreign Application Priority Data
Jul. 18, 2023 (DE) 202023104009.8

(51) Int. Cl. B23K 26/352; B23K 26/08; B23K 26/16

(52) U.S. Cl. CPC B23K 26/352; B23K 26/0823; B23K 26/16

(57) ABSTRACT

Apparatus for the collective treatment of surfaces of bulk goods comprises a receiving device defining a receiving space for the objects, the receiving space accessible through an opening. An irradiation device introduces radiation into the receiving space and to treat objects in the receiving space. The receiving device movable with the receiving space to change the position and/or the alignment of the receiving space. The receiving device and the irradiation device being detachably connected such that the irradiation device is moved along with a movement of the receiving device and the relative alignment between the receiving space and the irradiation device remains unchanged.

### CROSS-REFERENCE TO RELATED APPLICATIONS AND CLAIM TO PRIORITY

This application is related to utility model application number DE 20 2023 104 009.8, filed Jul. 18, 2023, in Germany, the complete disclosure of which is incorporated herein by reference and to which priority is claimed.

### FIELD OF THE INVENTION

The present invention relates to a device for the collectively treatment of surfaces of a plurality of objects, in particular bulk goods, with a receiving device, which defines a receiving space for the objects to be treated, the receiving space being accessible through an opening of the receiving device, and an irradiation device, which is arranged and designed to introduce radiation into the receiving space and thus to treat objects introduced into the receiving space, wherein the receiving device is movable with the receiving space, in particular in order to change the position and/or the orientation of the receiving space.

### BACKGROUND OF THE INVENTION

Such devices for the collective treatment of surfaces are known from EP 3 932 572 A1 and are primarily used to subject the surfaces of a large number of components to laser treatment and thus to clean, roughen, etc. For this purpose, the known device has a receiving device which defines a receiving space into which the components to be treated are placed in bulk. Furthermore, an irradiation device is provided in order to irradiate the components located in the receiving space with laser radiation. The components to be irradiated are mixed by moving the receiving device as a whole or a receiving drum, a receiving basket or the like of the receiving device in which the components are located.

It has been shown that very good cleaning results can be achieved with the known device. However, efforts are being made to further improve the quality of treatment.

### SUMMARY OF THE INVENTION

Against this background, the present application is based on the task of designing a device for the collective treatment of surfaces of a plurality of objects of the aforementioned type in such a way that the treatment quality is improved.

This task is solved in a device of the type mentioned at the beginning in that the receiving device and the irradiation device are connected to one another, in particular detachably connected, in such a way that the irradiation device is also moved when the receiving device is moved, so that the relative alignment between the receiving space and the irradiation device remains unchanged.

The invention is thus based on the idea of firmly connecting the irradiation device on the one hand and the receiving device on the other during operation in such a way that a predetermined alignment between the irradiation device and the receiving space is maintained even if the alignment of the receiving device is changed. It has been shown that this can improve the treatment quality of the bulk material.

According to one embodiment of the invention, it is provided that the irradiation device is arranged opposite the opening of the receiving device in order to introduce radiation through the opening into the receiving space from the outside.

For example, the irradiation device can be provided on a holding device, in particular on a holding arm or a holding frame, of the holding device which spans the opening of the receiving device on the outside, whereby the irradiation device is then fixed to the holding arm/holding frame. The arrangement is provided in such a way that the irradiation device is positioned in front of the opening of the receiving device or even protrudes through the opening into the receiving device.

According to an arrangement of one embodiment it is provided that the holding arm/holding frame is held pivotably on the receiving device and can be pivoted between a working position, in which the holding device or the holding arm/holding frame spans the opening of the receiving device, and a loading position, in which the holding arm/holding frame is pivoted away from a working position in order to clear the opening of the receiving device. To load/unload the receiving device, the holding arm is thus brought into its filling position, in which the opening of the receiving device is cleared. For operation, the holding arm/holding frame is pivoted into its working position and fixed in this position, in which the irradiation device can irradiate into the receiving space.

In a known manner, the receiving device can have a receiving drum defining the receiving space, which is held, or can be held on a frame or a housing of the receiving device and can be rotated relative thereto about an axis of rotation, in particular rotating and/or wobbling. The axis of rotation expediently extends centrally through the opening of the receiving device and is in particular directed perpendicular to a plane of the opening. In this case, the irradiation device is connected to the frame or the housing of the holding device. In particular, the holding device can be attached to the frame or the housing of the holding device.

Alternatively, the receiving device can also simply be formed by a receiving container, for example a receiving basket, which defines the receiving space. In this case, the radiation device is attached to the receiving container.

In one embodiment of the invention, it is provided that the holding device is mounted so as to be pivotable, in particular about a horizontal pivot axis. The inclination of the holding device can be adjusted by executing a corresponding pivoting movement. Conveniently, the pivot axis and the axis of rotation are perpendicular to each other.

According to a further embodiment of the invention, it is provided that fastening means are provided for to fastening the arrangement comprising the receiving device and the irradiation device to a robot arm. In this embodiment, as an alternative to the pivoting mounting of the receiving device, it is provided that the entire arrangement comprising the receiving device and irradiation device is suspended from a robot arm in order to be able to be moved by the latter.

In an alternative manner, according to a further embodiment of the invention, it is provided that the irradiation device is attached to a holding device designed as a gripper, which is provided or can be attached to a robot arm and which is designed to grip the receiving device in order to detachably attach the irradiation device to the receiving device.

In this case, the device may be characterized by a robot with a robot arm to which the gripper is attached. In this embodiment, the robot has a gripper which forms part of the holding device and by means of which the receiving device can be gripped in order to be moved by the robot. The irradiation device is mounted on the gripping device so that the desired fixed alignment between the irradiation device and the receiving space of the receiving device is ensured when the receiving device has been gripped by the gripping device of the robot.

As already described above, the receiving device can be formed by a simple receiving container, for example a basket, which defines the receiving space that is filled with the components to be treated. In this case, the gripper is connected directly to the receiving container. In an embodiment in which the receiving device has a rotating drum that is mounted in a frame housing of the receiving device, the gripper is connected to the frame or the housing.

According to the invention, the irradiation device is moved or guided along with a movement of the receiving device. However, the position and/or the orientation of the irradiation device relative to the receiving device can be freely adjusted. In particular, it is possible to automatically change the position and/or orientation of the irradiation device in a desired manner when the orientation and/or position of the receiving space of the receiving device is changed. Appropriate controls or regulations are provided for this purpose.

The irradiation device can have at least one irradiation source, which is designed in particular as a laser beam source, whereby, preferably, each irradiation source can be individually adjusted relative to the receiving device in order to set the position and/or the alignment. In particular, several radiation sources can be provided. It is then also possible to adjust these in different ways when changing the position/orientation of the receiving space. Finally, it may be provided that each radiation source comprises an associated optical system.

Finally, the device according to the invention can have an extraction device, which is arranged and designed to extract process vapors from the receiving space of the receiving device. The extraction device can be attached to the holding device, in particular to the holding arm or holding frame or the gripping device, which also carries the irradiation device.

### BRIEF DESCRIPTION OF THE DRAWINGS

With regard to further embodiments of the invention, reference is made to the following description of the embodiments with reference to the accompanying drawing. In the drawing shows

FIG. 1 device for the collective treatment of surfaces according to a first embodiment of the present invention in schematic front view,

FIG. 2 the device shown in FIG. 1, with the holding device pivoted clockwise about a horizontal axis relative to FIG. 1,

FIG. 3 the device shown in FIG. 1, wherein a holding arm carrying the irradiation device is swiveled clockwise into its filling position relative to the receiving device,

FIG. 4 a second embodiment of a device according to the invention for the collective treatment of surfaces according to the present invention, and

FIG. 5 the device from FIG. 2, wherein the receiving device and the irradiation device are separated from each other for filling or changing the receiving space.

### DETAILED DESCRIPTION OF THE PREFERRED EMBODIMENT(S)

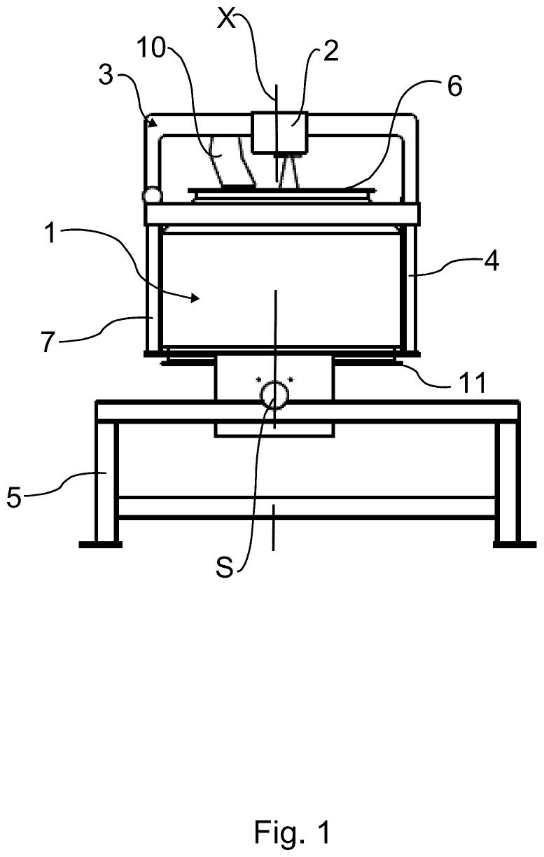

FIGS. 1 to 3 show a first embodiment of a device according to the invention for the collective treatment of surfaces of a plurality of objects. The device comprises a holding device 1 and an irradiation device 2, which is fixed to the holding device 1 via a holding device 3.

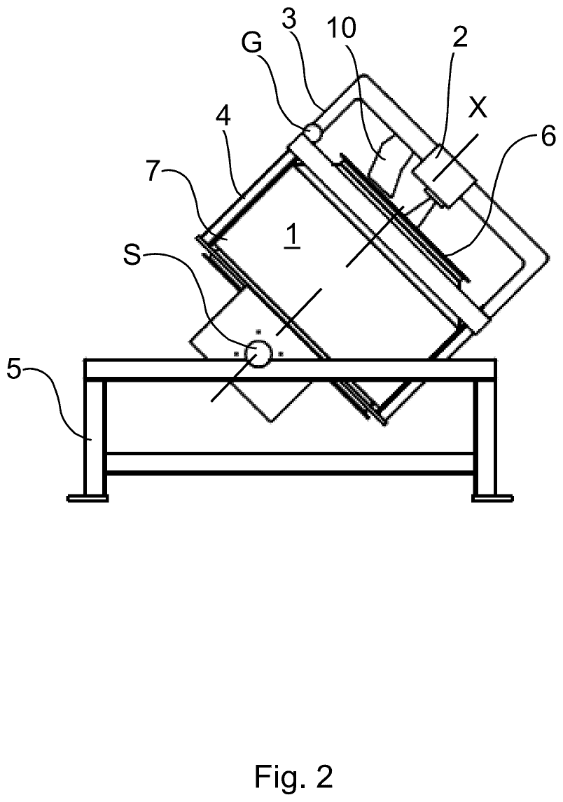

The holding device 1 comprises a housing 4, which is designed as a laser protection housing and can be pivoted on a frame 5 about a horizontal pivot axis S, which runs perpendicular to the image plane of FIGS. 1 to 3, as can be seen from a comparison of FIGS. 1 and 2. The holding device 1 also comprises a drum 7, which defines a receiving space into which the objects to be treated are filled as bulk goods and which is accessible through an opening 6 located at the top in FIG. 1. The drum 7 is mounted in the housing 4 to rotate about an axis of rotation X, which is vertical in FIG. 1 and runs in the image plane and is therefore perpendicular to the pivot axis S.

In the illustrated embodiment example, the irradiation device 2 comprises a laser beam device in the form of a laser head, which is arranged opposite the opening 6 of the receiving device 1 in order to introduce radiation through the opening 6 into the receiving space from the outside.

The irradiation device 2 can also include an optical system associated with the laser head.

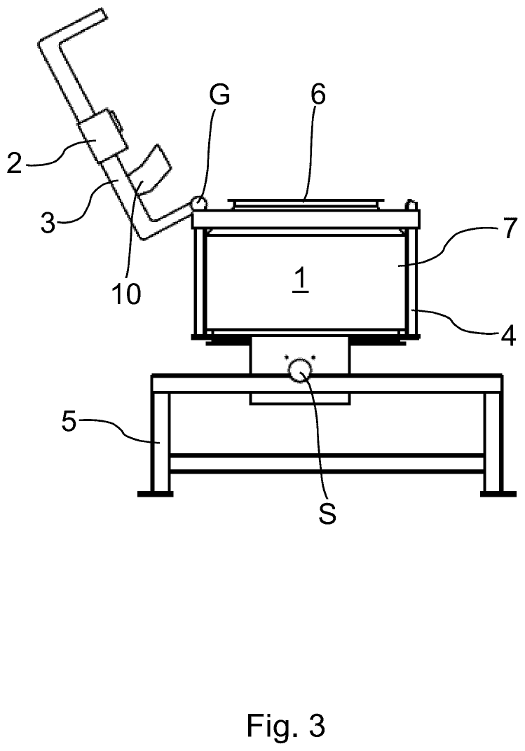

The holding device 3 is designed as a holding arm which, as can be seen in FIG. 1, spans the opening 6 of the holding device 1 in its working position, so that radiation can be introduced into the receiving space of the holding device 1 by means of the irradiation device 2 attached to the holding arm. One end of the holding arm is connected to the housing 4 of the receiving device 1 via a joint G and can be pivotally moved between the working position shown in FIG. 1, in which the holding arm spans the opening 4 of the receiving device, and a filling position, in which the holding arm is pivoted away from its working position in order to clear the opening 6 of the receiving device 1 (see FIG. 3).

The device according to the invention also comprises an extraction device which serves to extract process vapors from the receiving space of the holding device 1. All that can be seen of the holding device is a suction spout 10, which is fixed to the holding arm of the holding device 3.

In the device, the receiving device 1 and the irradiation device 2 are thus firmly connected to each other in the working position of the holding arm, so that the irradiation device 2 is also pivoted accordingly when the receiving device 1 is pivoted about the pivot axis S, with the result that the relative alignment between the receiving space and the irradiation device 2 remains unchanged, see FIGS. 1 and 2. The position and angular orientation of the irradiation device 2 in relation to the holding arm can be changed, so that in each swivel position of the receiving device 1 it is possible to set which area of the receiving space is directly irradiated by the irradiation device 2. A control device can also be provided which automatically adjusts the position and/or the angular position of the irradiation device 2 depending on the pivot position of the holding device 1.

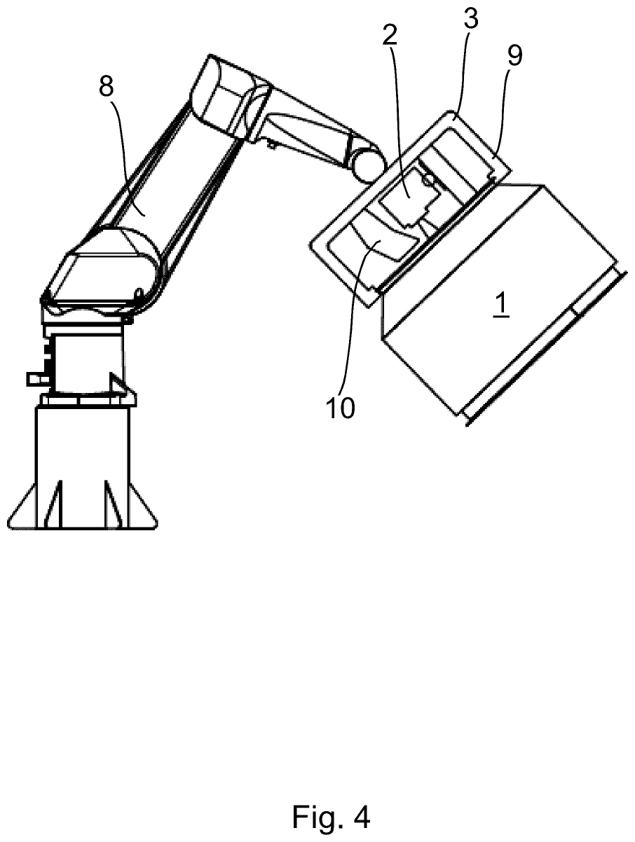

FIG. 4 shows a second embodiment of a device according to the invention for the collective treatment of surfaces of a plurality of objects according to the present invention. In this embodiment, the receiving device 1 is designed in the same way as in the first embodiment, so that reference is made to the corresponding explanations. However, the receiving device 1 is not supported and pivotally mounted on a frame as in the first embodiment, but is freely movable.

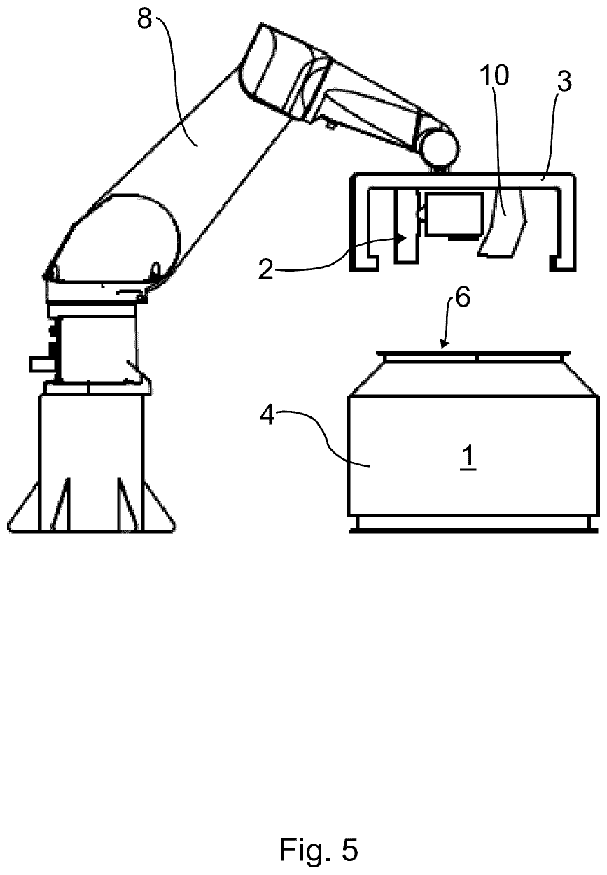

In contrast to the first embodiment, the holding device 3 is not attached to the housing 4 of the receiving device 1, but is designed in the form of a gripper 9, which carries the irradiation device 2 and is attached to a robot 8. To connect the holding device 3 to the receiving device 1, the robot 8 is positioned so that the gripper 9 grips the upper edge of the housing 4 of the receiving device 1 and the gripper 9 is actuated to establish the connection, as shown in FIG. 5. By actuating the robot 8, the arrangement or unit consisting of the receiving device 1, holding device 3 and irradiation device 2 can be brought into different pivot positions, as shown in a comparison of FIGS. 4 and 5, and in each pivot position the drum 5 of the receiving device 1 can be rotated and can also be rotated in a tumbling manner by the movement possibilities of the robot. It is also possible, as described above, to adjust the position and/or the angular position of the irradiation device 2. In this way the bulk goods in the receiving space can be revolted and irradiated uniformly.

I claim:

1. Device for the collective treatment of surfaces of a plurality of objects, in particular bulk goods, with
a receiving device (1) which defines a receiving space for the objects to be treated, the receiving space being accessible through an opening (6) of the receiving device (1), and
an irradiation device (2) which is arranged and designed to introduce radiation into the receiving space and thus to treat objects introduced into the receiving space,
wherein the receiving device (1) is movable with the receiving space, in particular in order to change the position and/or the orientation of the receiving space,
wherein
the receiving device (1) and the irradiation device (2) are connected to one another, in particular detachably connected, in such a way that the irradiation device (2) is also moved when the receiving device (1) is moved, so that the relative alignment between the receiving space and the irradiation device (2) remains unchanged.

2. Device for the collective treatment of surfaces of a plurality of objects according to claim 1, wherein the irradiation device (2) is arranged opposite the opening (6) of the receiving device in order to introduce radiation through the opening (6) into the receiving space from the outside.

3. Device for the collective treatment of surfaces of a plurality of objects according to claim 1, wherein the irradiation device (2) is provided on a holding device, in particular on a holding arm or a holding frame of the holding device (3), which spans the opening (6) of the receiving device (1) on the outside, and the irradiation device (2) is fixed to the holding device (3), wherein the holding device is preferably pivotably held on the receiving device (1) and can be pivoted between a working position, in which the holding device (3) spans the opening (6) of the receiving device (1), and a filling position, in which the holding device (3) is pivoted away from its working position in order to clear the opening (6) of the receiving device (1).

4. Device for the collective treatment of surfaces of a plurality of objects according to claim 1, wherein the receiving device (1) has a drum (7) defining the receiving space, which drum can be held or is held on a frame or a housing (4) of the receiving device (1) and can be rotated relative thereto about an axis of rotation (X), in particular rotating or tumbling.

5. Device for the collective treatment of surfaces of a plurality of objects according to claim 4, wherein the axis of rotation (X) runs centrally through the opening (6) of the receiving device (1) and is directed in particular perpendicular to a plane of the opening (6).

6. Device for the collective treatment of surfaces of a plurality of objects according to claim 1, wherein the receiving device (1) is mounted. so as to be pivotable, in particular about a horizontal pivot axis(S).

7. Device for the collective treatment of surfaces of a plurality of objects according to claim 4, wherein the pivot axis(S) and the axis of rotation (X) are perpendicular to each other.

8. Apparatus for the collective treatment of surfaces of a plurality of objects according to claim 1, wherein fastening means (11) are provided for fastening the arrangement of receiving device (1) and irradiation device (2) to a robot arm.

9. Apparatus for the collective treatment of surfaces of a plurality of objects according to claim 8, wherein a robot (8) with a robot arm, on which the arrangement consisting of receiving device (1) and irradiation device (2) is held and can be moved by a movement of the robot arm.

10. Apparatus for the collective treatment of surfaces of a plurality of objects according to claim 1, wherein the irradiation device (2) is attached to a gripper (9) which is provided on or can be attached to a robot arm and which is adapted to grip the receiving device (1) in order to detachably attach the irradiation device (2) to the receiving device (1).

11. Device for the collective treatment of surfaces of a plurality of objects according to claim 10, wherein a robot (8) with a robot arm to which the gripper (9) is attached.

12. Device for the collective treatment of surfaces of a plurality of objects according to claim 1, wherein the position and/or the orientation of the irradiation device (2) relative to the receiving device (1) can be adjusted and, in particular, can also be changed during operation of the device.

13. Device for the collective treatment of surfaces of a plurality of objects according to claim 1, wherein the irradiation device (2) has at least one radiation source, which is designed in particular as a laser beam source, wherein preferably, each radiation source is individually adjustable with respect to the receiving device (1), wherein, preferably, each radiation source comprises an associated optical system.

14. Apparatus for the collective treatment of surfaces of a plurality of objects according to claim 1, wherein the apparatus has an extraction device for extracting process vapours from the receiving space.

15. Device for the collective treatment of surfaces of a plurality of objects according to claim 2, wherein the irradiation device (2) is provided on a holding device, in particular on a holding arm or a holding frame of the holding device (3), which spans the opening (6) of the receiving device (1) on the outside, and the irradiation device (2) is fixed to the holding device (3), wherein the holding device is preferably pivotably held on the receiving device (1) and can be pivoted between a working position, in which the holding device (3) spans the opening (6) of the receiving device (1), and a filling position, in which the holding device (3) is pivoted away from its working position in order to clear the opening (6) of the receiving device (1).

16. Device for the collective treatment of surfaces of a plurality of objects according to claim 2, wherein the receiving device (1) has a drum (7) defining the receiving space, which drum can be held or is held on a frame or a housing (4) of the receiving device (1) and can be rotated relative thereto about an axis of rotation (X), in particular rotating or tumbling.

17. Device for the collective treatment of surfaces of a plurality of objects according to claim 3, wherein the receiving device (1) has a drum (7) defining the receiving space, which drum can be held or is held on a frame or a housing (4) of the receiving device (1) and can be rotated relative thereto about an axis of rotation (X), in particular rotating or tumbling.

18. Device for the collective treatment of surfaces of a plurality of objects according to claim 2, wherein the receiving device (1) is mounted. so as to be pivotable, in particular about a horizontal pivot axis(S).

19. Device for the collective treatment of surfaces of a plurality of objects according to claim 3, wherein the receiving device (1) is mounted. so as to be pivotable, in particular about a horizontal pivot axis(S).

20. Device for the collective treatment of surfaces of a plurality of objects according to claim 4, wherein the receiving device (1) is mounted. so as to be pivotable, in particular about a horizontal pivot axis(S).
